(19) United States
(12) Patent Application Publication
(10) Pub. No.: US 2026/0274384 A1
(43) Pub. Date: Sep. 17, 2026

(54) SHIP PIPE ROUTING METHOD BASED ON ARTIFICIAL BEE COLONY ALGORITHM

(71) Applicants: China University of Petroleum (East China), Qingdao (CN); Qingdao University of Science and Technology, Qingdao (CN)

(72) Inventors: Lei Wu, Qingdao (CN); Chao Liu, Qingdao (CN); Guangxin Li, Qingdao (CN); Wensheng Xiao, Qingdao (CN); Dengpan Xu, Qingdao (CN); Xiaokang Wei, Qingdao (CN); Qihang Feng, Qingdao (CN); Jingkun Gao, Qingdao (CN); Shuai An, Qingdao (CN); Junming Han, Qingdao (CN); Junwei Wang, Qingdao (CN); Yuchong Sun, Qingdao (CN); Yue Hu, Qingdao (CN)

(21) Appl. No.: 19/433,996

(22) Filed: Dec. 29, 2025

(30) Foreign Application Priority Data
Mar. 13, 2025 (CN) 202510292888.9

(51) Int. Cl. B63B 71/10; G06N 3/004

(52) U.S. Cl. CPC B63B 71/10; G06N 3/004

(57) ABSTRACT

A ship pipe routing method based on an artificial bee colony algorithm is provided, which relates to the technical filed of ship pipe planning. The method includes: step 1, simplifying expressions of devices and a layout space to build a mathematical model for a pipe routing problem; step 2, generating, by using a chaotic elite opposition-based learning strategy, elite initial solutions of the mathematical model for the pipe routing problem; and step 3, continuously updating, by using optimally guided employed bees, spirally searching onlooker bees, and scout bees, the elite initial solutions until a convergence condition is satisfied, to obtain a pipe coordinate solution. The efficiency of path planning and the quality of layout design are improved, and design costs are reduced.

### TECHNICAL FIELD

The disclosure relates to the technical field of ship pipe planning, and more particularly to a ship pipe routing method based on an artificial bee colony algorithm.

### BACKGROUND

Pipe routing design plays a vital role in an overall design of ships. A rational pipe layout can reduce ship energy consumption, and a well-designed piping system facilitates maintenance and repair. Pipe routing design is crucial for the performance, safety, and economical operation of ships. With the continuous development of digitalization and intelligence, the trend towards intelligentization in the field of pipe routing is already unstoppable. Currently, numerous scholars and designers are adopting intelligent algorithms to address pipe routing problems. A Chinese patent application with publication No. CN115587453A discloses an automatic ship pipe routing calculation method. This method, based on a ship cabin structure and piping rules, achieves single-pipe routing path solving by using an A* algorithm, and achieves multi-pipe routing path solving through pipe priority sorting and cost value correction methods. However, when deterministic algorithms like A* are used to solve pipe routing problems, their search performance decreases exponentially as the layout space expands. Among intelligent algorithms, the artificial bee colony (ABC) algorithm is a classic heuristic search algorithm, which has attracted much attention due to its efficient search capability and has become one of the research hotspots. However, the traditional ABC algorithm has several limitations when applied to pipe routing. Firstly, the traditional ABC algorithm is significantly affected by the initial solutions. Secondly, without modification, the traditional ABC algorithm cannot be directly used to solve the pipe routing problem.

### SUMMARY

A technical problem to be solved in the disclosure is to provide a ship pipe routing method based on an artificial bee colony algorithm to overcome disadvantages in the related art.

The technical solution adopted by the disclosure to solve the technical problem is as follows. A ship pipe routing method based on an artificial bee colony algorithm includes:
step 1, simplifying expressions of devices and a layout space to build a mathematical model for a pipe routing problem;
step 2, generating, by using a chaotic elite opposition-based learning strategy, elite initial solutions of the mathematical model for the pipe routing problem;
step 3, continuously updating, by using optimally guided employed bees, spirally searching onlooker bees, and scout bees, the elite initial solutions until a convergence condition is satisfied, to obtain a pipe coordinate solution; and
step 4, obtaining the pipe coordinate solution, orthogonalizing the pipe coordinate solution to obtain an orthogonalized coordinate solution, and converting the orthogonalized coordinate solution into a node solution as a final solution for the pipe routing problem.

In an exemplary embodiment, the ship pipe routing method further includes:
importing the final solution for the pipe routing problem into a ship computer-aided design system to generate a pipe routing model, and installing, according to the pipe routing model, pipe brackets in a ship, and laying pipes on the pipe brackets to thereby form a ship pipe system.

In an embodiment, the step 1 includes:
step 1-1, simplifying, by using an axis-aligned bounding box method, the expressions of the devices in a ship;
step 1-2, simplifying, according to a central axis theory, each pipe connection position into a point, and an entire pipe into a centerline; and
step 1-3, determining a target function of the mathematical model for the pipe routing problem.

In an embodiment, the objective function of the mathematical model for the pipe routing problem is determined as a minimum weighting function min F (x), and the minimum weighting function is expressed as follows:

$$min F ( x ) = {\sum }_{i = 1}^{n} {w}_{i} {X}_{i} ;$$

$$subject to \{ \begin{matrix}lb < {X}_{ij} < ub \\ {X}_{ij} \neq {X}_{ij \_ no} \\ {X}_{ij} \neq {X}_{ik} ( j \neq k )\end{matrix} ;$$

where Xᵢ represents an i^{th} optimization objective; wᵢ represents a weight factor of the i^{th} optimization objective; Xᵢⱼ represents pipe storage information of each optimization objective, and represented as a j^{th} pipe node in an i^{th} solution; X_{ij_no} represents a set of infeasible grids; lb represents a lower limit of the layout space; ub represents an upper limit of the layout space; i, j and k represent natural numbers, and j and k are pipe nodes in different dimensions.

In an embodiment, each initial solution is constructed as Xᵢ=(X_{i,1}, X_{i,2}, . . . . X_{i,j} . . . X_{i,D}), X_{i,j} represents a j^{th} node of an i^{th} pipe, and D represents a natural number. The step 2 includes:
step 2-1, generating a set of basic solutions, and filtering out elite individuals with most outstanding performances from the set of basic solutions as elite solutions;
step 2-2, performing chaotic opposition-based learning on the elite solutions to generate another set of solutions; and
step 2-3, filtering out elite individuals from the sets of basic solutions and the another set of solutions to generate the elite initial solutions.

In an embodiment, the step 3 includes:
step 3-1, in an employed bee phase, guiding a search direction based on a current best solution and a global best solution, and adjusting, based on influence factors of the current best solution and the global best solution, an influence degree of the current best solution and the global best solution on the search direction, thereby updating the elite initial solutions to obtain first updated solutions; and
step 3-2, in an onlooker bee phase, performing, by onlooker bees, spiral exploitation around the global best solution, exchanging, by the onlooker bees, information with other solutions to search from different angles and directions to increase a possibility of jumping out of a local best solution, thereby updating the first updated solutions to obtain second updated solutions.

In an embodiment, the step 3-1 includes:
step 3-1-1, calculating the current best solution;
step 3-1-2, calculating the global best solution; and
step 3-1-3, adjusting, based on the influence factors of the current best solution and the global best solution, the influence degree of the current best solution and the global best solution to control the search direction, thereby updating the current solutions to obtain the first updated solutions; wherein an expression of each of the first updated solutions is as follows:

$${X}_{i , j} = {X}_{i , j} + ϕ ( {X}_{i , j} - {X}_{k , j} ) + {λ}_{1} ( {X}_{pbest , j} - {X}_{i , j} ) + {λ}_{2} ( {X}_{gbest , j} - {X}_{i , j} ) ;$$

where φ represents a random number within an interval [−1,1]; λ₁ and λ₂ represent the influence factors of the current best solution and the global best solution respectively, being 1.5 and 1 in a first half of iterations, and 1 and 1.5 in a second half of iterations; and X_{pbest} and X_{gbest} represent the current best solution and the global best solution, respectively.

In an embodiment, in the step 3-1-1, the current best solution is a solution with a best fitness value among the employed bees in a current iteration number.

In an embodiment, in the step 3-1-2, the global best solution is a best solution in a completed iteration process.

In an embodiment, in the step 3-2, an expression of each second updated solution is as follows:

$${X}_{i}^{new} = {X}_{gbest} + {a}_{1} \cdot rand \cdot ( {X}_{i} - {X}_{k} ) + {a}_{2} \cdot β \cdot ( {X}_{gbest} - {X}_{i} ) ;$$

where a₁ and a₂ represent weight coefficients controlling tendency of the onlooker bees to move towards other bees and the global best solution, respectively, i and k represent numbers of current onlooker bees respectively, rand represents a function generating a random number between 0 and 1, and β represents a spiral control parameter.

In an embodiment, in step 4, the orthogonalized coordinate solution is converted into the node solution as the final solution for the pipe routing problem through the following conversion formulas:

$$\{ \begin{matrix}{P}_{x} = mod ( P , {R}_{x} ) - 0.5 \\ {P}_{y} = {R}_{y} + 0 \text{.5} - ceil ( P / {R}_{y} ) \\ P = ( {P}_{x} + d / 2 ) + ( {R}_{x} - d / 2 - {P}_{y} ) \times {R}_{x}\end{matrix} ;$$

where Pₓ and P_{y} represents solutions calculated by the artificial bee colony algorithm, corresponding to coordinate information of a pipe node mapped onto a grid map, P represents pipe node information, mod represents a modulo calculation, ceil represents a round-up calculation, d represents a grid size, and Rₓ and R_{y} represents a number of rows and a number of columns of the grid map, respectively.

Compared to the related art, the disclosure has the following beneficial effects.

The disclosure proposes an improved artificial bee colony algorithm for ship pipe routing design, which enhances path planning efficiency, improves the quality of layout design, and reduces design costs. The disclosure provides effective reference for designers, thereby enabling the pipe layout to better meet the complex multi-objective and multi-constraint requirements of ship pipe routing design. This holds significant engineering importance for the intellectualization and automation of pipe routing design.

The disclosure adopts the improved artificial bee colony algorithm for ship pipe routing design, resulting in a layout efficiency that is less affected to the size of the layout space. Compared to deterministic algorithms, it is less prone to becoming trapped in local optima, thereby leading to a significant improvement in layout efficiency and quality.

The disclosure proposes a chaotic elite opposition-based learning strategy, which enhances the quality of the initial solutions and accelerates the convergence speed.

The disclosure proposes an employed bee search formula guided by the crossover of the current best solution and the global best solution, thereby giving the search a more directional nature.

The disclosure proposes an onlooker bee search formula that references random solutions and performs spiral exploitation around the global best solution, which improves the efficiency of exploitation and, to a certain extent, avoids becoming trapped in local optima.

### BRIEF DESCRIPTION OF DRAWINGS

FIG. 1 illustrates a flowchart of an artificial bee colony algorithm according to the disclosure.

FIG. 2 illustrates a schematic diagram of simulation results of a layout of an original artificial bee colony algorithm according to the disclosure.

FIG. 3 illustrates a schematic diagram of simulation results of a layout according to the disclosure.

### DETAILED DESCRIPTION OF EMBODIMENTS

Below, the technical solutions in the embodiments of the disclosure will be clearly and completely described in conjunction with the accompanying drawings. Apparently, the described embodiments are merely some of the embodiments of the disclosure, not all of the embodiments. Based on the embodiments of the disclosure, all other embodiments obtained by those skilled in the art without creative labor are within a scope of protection of the disclosure.

It should be noted that all directional indications (such as up, down, left, right, front and back) in the embodiments of the disclosure are only used to explain the relative position relationship and motion between the components in a specific posture (as shown in the drawings). If the specific posture changes, the directional indication will also change accordingly.

In the disclosure, terms such as “connected” and “fixed” should be understood broadly. For example, “fixed” may mean a fixed connection, a detachable connection, or being integrated into one unit; it may be a mechanical connection, an electrical connection, or a direct connection, or an indirect connection through an intermediary. It may refer to the internal communication between two components or the interaction between two components. For those skilled in the art, the specific meanings of the above terms in the disclosure can be understood based on the specific context.

The artificial bee colony algorithm is inspired by the foraging behavior of honeybees in nature, which divides a population into employed bees and onlooker bees. The traditional artificial bee colony algorithm first initializes the population by using the following formula to obtain initial solutions, with an initial solution update count set to zero. The specific formula is as follows:

$${X}_{j} = {lb}_{j} + rand \cdot ( {ub}_{j} - {lb}_{j} ) ;$$

where lb represents a lower limit of a layout space; ub represents an upper limit of the layout space; r and represents a function generating a random number between 0 and 1; and Xⱼ represents a solution in a j^{th} dimension.

Next, the process enters the employed bee phase. Employed bees update the initial solutions by referencing the information of the initial solutions according to the following formula. When a new solution is better than the old one (i.e., the initial solution), it replaces the old solution, and an update count for this solution is reset to zero; when not replaced, the update count for this solution is incremented by one. The formula is expressed as follows:

$${X}_{i , j} = {X}_{i , j} + ϕ ( {X}_{i , j} - {X}_{k , j} ) ;$$

where φ represents a random number within an interval [−1,1]; and X_{i,j} and X_{k,j} represent values of an i^{th} solution and a kth solution in the j^{th} dimension, respectively.

The onlooker bees select a solution with richest information for exploitation based on a greedy criterion. The richness of information is determined by a proportion of its fitness value relative to a sum of all solutions' fitness values. The calculation of information amount and the exploitation formulas are as follows:

$${p}_{i} = \frac{{fit}_{i}}{{\sum }_{i = 1}^{SN} {fit}_{i}} ;$$

$${X}_{i , j} = {X}_{i , j} + ϕ ( {X}_{i , j} - {X}_{k , j} ) ;$$

where pᵢ represents a richness of information of the i^{th} solution, fitᵢ represents a fitness value of the i^{th} solution, and SN represents a number of the solutions.

The solutions updated by the onlooker bees are also subject to replacement and update count calculation based on the greedy criterion. When a solution fails to be updated for an extended period, the bee corresponding to that solution transforms into a scout bee and generates a new solution according to the initialization formula.

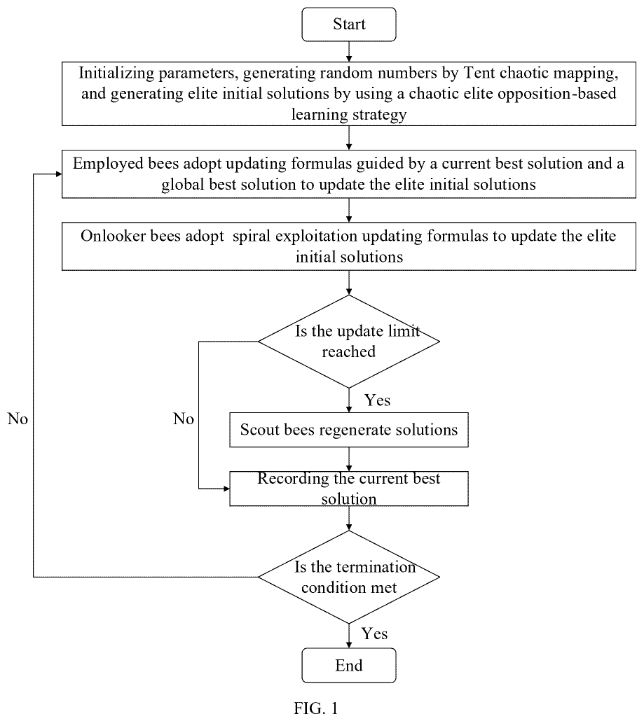

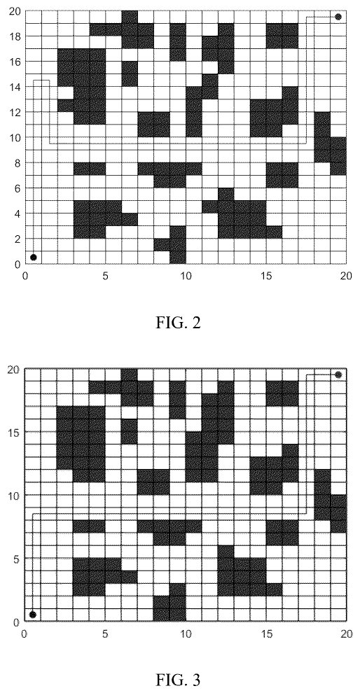

The disclosure improves a search mechanism and encoding rules of the traditional artificial bee colony algorithm, so that the algorithm is more suitable for solving the ship pipe routing problem. Referring to FIGS. 1-3, the ship pipe routing method based on the artificial bee colony algorithm includes the following steps 1-4.

In step 1, a grid method is used to simplify expressions of devices and a layout space to build a mathematical model for a pipe routing problem with objectives including routing length, number of bends, and facilitating bracket placement.

Only maximum geometric information of the devices in the ship's layout environment is required to meet the requirements while improving the algorithm's search speed. Therefore, the step 1 includes the following sub-steps 1-1 to 1-3.

In step 1-1, the expressions of the devices in a ship are simplified by using an axis-aligned bounding box method.

In step 1-2, the simplified pipe model does not affect the expression of the pipe path. Therefore, each pipe connection position is simplified into a point, and an entire pipe is simplified into a centerline according to a central axis theory.

In step 1-3, an objective function of the mathematical model for the pipe routing problem primarily considers influence of pipe length and bends. Additionally, an energy value is introduced to encourage paths to be close to suitable bracket placement locations, thereby achieving the goal of facilitating bracket installation. The objective function of the mathematical model for the pipe routing problem is determined.

The objective function of the mathematical model for the pipe routing problem is determined as a minimum weighting function min F (x), which simplifies a multi-objective problem into a single-objective problem by using a linear weighting method. The minimum weighting function is expressed as follows:

$$min F ( x ) = {\sum }_{i = 1}^{n} {w}_{i} {X}_{i} ;$$

$$subject to \{ \begin{matrix}lb < {X}_{ij} < ub \\ {X}_{ij} \neq {X}_{ij \_ no} \\ {X}_{ij} \neq {X}_{ik} ( j \neq k )\end{matrix} ;$$

where Xᵢ represents an i^{th} optimization objective; wᵢ represents a weight factor of the i^{th} optimization objective; Xᵢⱼ represents pipe storage information of each optimization objective, and represented as a j^{th} pipe node in an i^{th} solution; X_{ij_no} represents a set of infeasible grids; lb represents a lower limit of the layout space; ub represents an upper limit of the layout space; i, j and k represent natural numbers, and j and k are pipe nodes in different dimensions.

In step 2, initial solutions of the mathematical model for the pipe routing problem calculated by the artificial bee colony algorithm are improved by using a chaotic elite opposition-based learning strategy to obtain elite initial solutions. In order to adapt to solving the ship pipe routing problem, all elite initial solutions are constructed as Xᵢ=(X_{i,1}, X_{i,2}, . . . . X_{i,j} . . . X_{i,D}), X_{i,j} represents a j^{th} node of an i^{th} pipe, and D represents a natural number.

The disclosure uses a chaotic elite opposition-based learning strategy to generate the elite initial solutions, which offers significant advantages. The step 2 includes the following sub-steps 2-1 to 2-3.

In step 2-1, a set of basic solutions are generated according to a generation formula of an initial solution of the traditional artificial bee colony algorithm, which lays the foundation for the subsequent optimization process. From the set of basic solutions, the basic solutions are sorted by calculating a fitness value of each basic solution to select solutions with best fitness values as elite solutions (i.e., elite individuals). These elite individuals possess high quality and potential and are key to further optimization. The fitness value of each basic solution is the sum of the pipe length and the number of bends.

In step 2-2, chaotic opposition-based learning is performed on the elite solutions to generate another set of solutions, as detailed in the following formula. The opposition-based learning process can fully exploit potential information of the elite solutions, expand the solution space, and provide more possibilities for finding better solutions. In this way, both sets of solutions obtained have certain value.

Furthermore, a point X^{e} in a D-dimensional space is defined as the elite individual of the initial solution set (corresponding to the step 2-1), and X^{e} is expressed as follows:

$${X}^{e} = ( {X}_{1}^{e} , {X}_{2}^{e} , … , {X}_{j}^{e} ) ( j = 1 , 2 , … , D ) ;$$

where

$${X}_{j}^{e}$$

represents a value of the elite solution in the j^{th} solution; and D represents an upper dimension limit.

An opposite solution \tilde{X}^{e} is expressed as

$${{X}^{⌣}}^{e} = ( {{X}^{⌣}}_{1}^{e} , {{X}^{⌣}}_{2}^{e} , … , {{X}^{⌣}}_{j}^{e} ) ,$$

which is defined as follows:

$${{X}^{⌣}}_{j}^{e} = {φ}_{T} ( {α}_{j} + {β}_{j} ) - {X}_{i , j}^{e} ;$$

where φ_{T} represents a random number within the interval [0,1] generated Tent chaotic mapping; αⱼ and βⱼ represent dynamic boundary conditions; compared to fixed boundary conditions, they allow the construction of elite opposite solutions in a more precise search space, where αⱼ=min (X_{i,j}), and βⱼ=max (X_{i,j}).

In order to prevent the elite opposite point from crossing the boundary and becoming an infeasible solution, a randomization method is used for resetting, expressed as follows:

$${{X}^{⌣}}_{j}^{e} = rand ( {α}_{j} , {β}_{j} ) .$$

In step 2-3, elite individuals are filtered out again from the two sets of solutions. These elite individuals collectively form the elite initial solutions.

The chaotic elite opposition-based learning strategy significantly improves the quality and diversity of the initial solutions. The improvement in quality makes it more likely for the initial solutions to guide the optimization process towards a better direction, thereby reducing ineffective searches and iterations. The increase in diversity provides a broader search space for the optimization process, thereby helping to avoid getting trapped in local optima. This strategy effectively enhances search efficiency and solution accuracy of the algorithm, thereby providing strong support for solving complex pipe routing optimization problems.

In step 3, the elite initial solutions are continuously updated by using optimally guided employed bees, spirally searching onlooker bees, and scout bees until a convergence condition is satisfied to obtain a pipe coordinate solution. The step 3 includes the following sub-steps 3-1 to 3-2.

In step 3-1, in an employed bee phase, a search direction is explicitly guided based on a current best solution and a global best solution. The influence degree of the current best solution and the global best solution on the search direction is adjusted based on weights (i.e., influence factors) of the current best solution and the global best solution, thereby updating the elite initial solutions to obtain first updated solutions.

In the employed bee phase, the search primarily revolves around the best solutions for in-depth exploration and exploitation. The importance of this phase lies in its significant impact on the entire convergence speed and solution quality of the algorithm. The traditional artificial bee colony algorithm often relies on information from two random solutions for exploitation, which is a method characterized by uncertainty and blindness. Different from the traditional artificial bee colony algorithm, the improved algorithm introduces explicit guidance of the search direction by the current best solution and the global best solution. The current best solution represents the best-performing solution in the current iteration process, which provides strong directional guidance for local search. The global best solution, from the perspective of the entire search process, represents the best solution found so far, which provides the algorithm with a global perspective and target. Specifically, the step 3-1 includes the following sub-steps 3-1-1 to 3-1-3.

In step 3-1-1, the current best solution is calculated, which is a solution with the best fitness value among the employed bees in the current iteration count. That is, after each iteration, the individual (i.e., solution) with a lowest fitness value in the population is recorded as the current best solution, and compared with a historical record global best solution. When the current best solution is better than the historical record global best solution, the historical record is replaced and updated as the current best solution.

In step 3-1-2, the global best solution is calculated, which is a best solution in a completed iteration process.

In step 3-1-3, the influence degree of the current best solution and the global best solution on the search direction is adjusted based on weights (i.e., influence factors) of the current best solution and the global best solution, thereby updating the elite initial solutions to obtain first updated solutions. The expression of each first updated solution is as follows:

$${X}_{i , j} = {X}_{i , j} + ϕ ( {X}_{i , j} - {X}_{k , j} ) + {λ}_{1} ( {X}_{pbest , j} - {X}_{i , j} ) + {λ}_{2} ( {X}_{gbest , j} - {X}_{i , j} ) ;$$

where φ represents a random number within an interval [−1,1]; λ₁ and λ₂ represent the influence factors of the current best solution and the global best solution respectively, being 1.5 and 1 in a first half of iterations, and 1 and 1.5 in a second half of iterations; and X_{pbest} and X_{gbest} represent the current best solution and the global best solution, respectively.

By adjusting the influence degree between the current best solution and the global best solution based on weights, the search direction can be more flexibly controlled. When the weight favors the current best solution, the algorithm focuses more on local fine-grained search, which enables deeper exploration near the current best solution to potentially find a better solution. When the weight favors the global best solution, the algorithm tends to explore globally, thereby avoiding getting trapped in local optima. This weight adjustment method allows the algorithm to adapt its search strategy according to different problems and search stages, thereby improving the adaptability and solution capability of the algorithm.

In step 3-2, in an onlooker bee phase, spiral exploitation is performed around the global best solution by the onlooker bees, the onlooker bees exchange information with other solutions to search from different angles and directions to increase a possibility of jumping out of a local best solution, thereby updating the first updated solutions to obtain second updated solutions.

After the employed bees complete updates, the onlooker bees exhibit characteristics distinctly different from those in the traditional ABC algorithm. In the traditional ABC algorithm, the onlooker bees use the same update formula as employed bees, which revolves around two random solutions. This method has certain limitations, as the uncertainty of random solutions can lead to blindness and inefficiency in the search process.

In the improved algorithm, the onlooker bees perform spiral exploitation around the global best solution. The global best solution is the currently known best solution in the entire search space, which provides a clear target and direction for the onlooker bees. By performing spiral exploitation around the global best solution, the onlooker bees can conduct a more targeted search in its vicinity, thereby improving search efficiency and accuracy.

The onlooker bees also exchange information with other solutions. This information exchange mechanism allows onlooker bees to acquire characteristics and advantages from different solutions, thereby enriching their own search strategies. Through interaction with other solutions, the onlooker bees can avoid becoming trapped in local optima. Local optima are a common problem in optimization algorithms. Once an algorithm falls into a local optimum, it is difficult to find better solutions. By exchanging information with other solutions, the onlooker bees can search from different angles and directions, thereby increasing the possibility of escaping local optima. The expression after updating the solution (i.e., an expression of the second updated solution)

$${X}_{i}^{new}$$

at this time is as follows:

$${X}_{i}^{new} = {X}_{gbest} + {a}_{1} \cdot rand \cdot ( {X}_{i} - {X}_{k} ) + {a}_{2} \cdot β \cdot ( {X}_{gbest} - {X}_{i} ) ;$$

$${a}_{1} = ( 1 - a ) - ( 1 - a ) \cdot \frac{t}{T} ;$$

$${a}_{2} = a + ( 1 - a ) \cdot \frac{t}{T} ;$$

$$β = {e}^{bl} \cdot cos ( 2 π l ) ;$$

where α₁ and α₂ represent weight coefficients controlling tendency of the onlooker bees to move towards other bees and the global best solution, respectively, a represents a constant, configured to determine a degree of movement tendency; i and k represent numbers of current onlooker bees respectively, rand represents a function generating a random number between 0 and 1, and β represents a spiral control parameter, T represents a total number of iterations, t represents a current iteration number, b represents a constant for defining the spiral shape, and l represents a random number within [−1,1].

In step 4, the pipe coordinate solution is calculated by using the improved artificial bee colony algorithm. The pipe coordinate solution is orthogonalized to obtain an orthogonalized coordinate solution. The orthogonalized coordinate solution is converted into a node solution via a conversion formula as a final solution for the pipe routing problem. When applied in a practical environment, the node solution can be converted back into the coordinate solution. Referring to the traditional artificial bee colony algorithm, when the solutions corresponding to either employed bees or onlooker bees reach the set upper limit of the update counts without being updated, they transform into scout bees and are updated according to the initial solution generation formula of the traditional artificial bee colony algorithm, with the update count reset to zero.

Simultaneously, considering the environmental description by the grid method and the requirement for pipe orthogonalization, the solution calculated iteratively by the artificial bee colony algorithm need to be converted into a node solution storing pipe information. The conversion formula is as follows:

$$\{ \begin{matrix}{P}_{x} = mod ( P , {R}_{x} ) - 0.5 \\ {P}_{y} = {R}_{y} + 0 \text{.5} - ceil ( P / {R}_{y} ) \\ P = ( {P}_{x} + d / 2 ) + ( {R}_{x} - d / 2 - {P}_{y} ) \times {R}_{x}\end{matrix} ;$$

where Pₓ and P_{y} represents solutions calculated by the artificial bee colony algorithm, corresponding to coordinate information of a pipe node mapped onto a grid map, P represents pipe node information, mod represents a modulo calculation, ceil represents a round-up calculation, d represents a grid size, and Rₓ and R_{y} represents a number of rows and a number of columns of the grid map, respectively.

For the pipe node solution obtained by the improved artificial bee colony algorithm, orthogonalization of the paths can be achieved by introducing an orthogonalization operation. That is, for two pipe nodes with their respective coordinate information (x1, y1) and (x2, y2), one can choose to add point (x1, y2) or point (x2, y1). Such an operation enables the path formed by the original two points to exhibit an orthogonal state, conforming to the design requirements of pipes.

The disclosure uses chaotic numbers for generating opposite solutions and incorporates a boundary control strategy. The disclosure improves the employed bee and onlooker bee search equations, uses the influence of other solutions, the current best solution, and the global best solution in the employed bee equation, and uses a spiral exploitation formula by the onlooker bee equation, to respectively enhance the exploration and exploitation capabilities of the artificial bee colony algorithm.

The above descriptions are only optional embodiments of the disclosure and are not intended to limit the patent scope of the disclosure. Any equivalent structural transformations made using the contents of the description and drawings of the disclosure, or direct/indirect application in other related technical fields, shall be included in the patent protection scope of the disclosure.

What is claimed is:

1. A ship pipe routing method based on an artificial bee colony algorithm, comprising:
step 1, simplifying expressions of devices and a layout space to build a mathematical model for a pipe routing problem;
step 2, generating, by using a chaotic elite opposition-based learning strategy, elite initial solutions of the mathematical model for the pipe routing problem; wherein each of the elite initial solutions is constructed as Xᵢ=(X_{i,1}, X_{i,2}, . . . X_{i,j} . . . X_{i,D}), X_{i,j} represents a j^{th} node of an i^{th} pipe, and D represents a natural number; and the step 2 comprises:
step 2-1, generating a set of basic solutions, and filtering out elite individuals with most outstanding performances from the set of basic solutions as elite solutions;
step 2-2, performing chaotic opposition-based learning on the elite solutions to generate another set of solutions; and
step 2-3, filtering out elite individuals from the sets of basic solutions and the another set of solutions to generate the elite initial solutions;
step 3, continuously updating, by using optimally guided employed bees, spirally searching onlooker bees, and scout bees, the elite initial solutions until a convergence condition is satisfied, to obtain a pipe coordinate solution; wherein the step 3 comprises:
step 3-1, in an employed bee phase, guiding a search direction based on a current best solution and a global best solution, and adjusting, based on influence factors of the current best solution and the global best solution, an influence degree of the current best solution and the global best solution on the search direction, thereby updating the elite initial solutions to obtain first updated solutions; wherein the step 3-1 comprises:
step 3-1-1, calculating the current best solution;
step 3-1-2, calculating the global best solution; and
step 3-1-3, adjusting, based on the influence factors of the current best solution and the global best solution, the influence degree of the current best solution and the global best solution to control the search direction, thereby updating the elite initial solutions to obtain the first updated solutions; wherein an expression of each of the first updated solutions is as follows:
$${X}_{i , j} = {X}_{i , j} + ϕ ( {X}_{i , j} - {X}_{k , j} ) + {λ}_{1} ( {X}_{pbest , j} - {X}_{i , j} ) + {λ}_{2} ( {X}_{gbest , j} - {X}_{i , j} ) ;$$
wherein φ represents a random number within an interval [−1,1]; λ₁ and λ₂ represent the influence factors of the current best solution and the global best solution respectively, being 1.5 and 1 in a first half of iterations, and 1 and 1.5 in a second half of iterations; and X_{pbest} and X_{gbest} represent the current best solution and the global best solution, respectively;
step 3-2, in an onlooker bee phase, performing, by onlooker bees, spiral exploitation around the global best solution, exchanging, by the onlooker bees, information with other solutions to search from different angles and directions to increase a possibility of jumping out of a local best solution, thereby updating the first updated solutions to obtain second updated solutions;
step 4, obtaining the pipe coordinate solution, orthogonalizing the pipe coordinate solution to obtain an orthogonalized coordinate solution, and converting the orthogonalized coordinate solution into a node solution as a final solution for the pipe routing problem.

2. The ship pipe routing method based on the artificial bee colony algorithm as claimed in claim 1, wherein the step 1 comprises:
step 1-1, simplifying, by using an axis-aligned bounding box method, the expressions of the devices in a ship;
step 1-2, simplifying, according to a central axis theory, each pipe connection position into a point, and an entire pipe into a centerline; and
step 1-3, determining an objective function of the mathematical model for the pipe routing problem.

3. The ship pipe routing method based on the artificial bee colony algorithm as claimed in claim 2, wherein the objective function of the mathematical model for the pipe routing problem is determined as a minimum weighting function min F (x), and the minimum weighting function is expressed as follows:
$$min F ( x ) = {\sum }_{i = 1}^{n} {w}_{i} {X}_{i} ;$$
$$subject to \{ \begin{matrix}lb < {X}_{ij} < ub \\ {X}_{ij} \neq {X}_{ij \_ no} \\ {X}_{ij} \neq {X}_{ik} ( j \neq k )\end{matrix} ;$$
wherein Xᵢ represents an i^{th} optimization objective; wᵢ represents a weight factor of the i^{th} optimization objective; Xᵢⱼ represents pipe storage information of each optimization objective, and represented as a j^{th} pipe node in an i^{th} solution; X_{ij_no} represents a set of infeasible grids; lb represents a lower limit of the layout space; ub represents an upper limit of the layout space; i, j and k represent natural numbers, and j and k are pipe nodes in different dimensions.

4. The ship pipe routing method based on the artificial bee colony algorithm as claimed in claim 1, wherein in the step 3-1-1, the current best solution is a solution with a best fitness value among the employed bees in a current iteration number.

5. The ship pipe routing method based on the artificial bee colony algorithm as claimed in claim 1, wherein in the step 3-1-2, the global best solution is a best solution in a completed iteration process.

6. The ship pipe routing method based on the artificial bee colony algorithm as claimed in claim 1, wherein in the step 3-2, an expression of each of the second updated solutions is as follows:
$${X}_{i}^{new} = {X}_{gbest} + {a}_{1} \cdot rand \cdot ( {X}_{i} - {X}_{k} ) + {a}_{2} \cdot β \cdot ( {X}_{gbest} - {X}_{i} ) ;$$
wherein a₁ and a₂ represent weight coefficients controlling tendency of the onlooker bees to move towards other bees and the global best solution, respectively, i and k represent numbers of current onlooker bees respectively, rand represents a function generating a random number between 0 and 1, and β represents a spiral control parameter.

7. The ship pipe routing method based on the artificial bee colony algorithm as claimed in claim 6, wherein in step 4, the orthogonalized coordinate solution is converted into the node solution as the final solution for the pipe routing problem through the following conversion formulas:
$$\{ \begin{matrix}{P}_{x} = mod ( P , {R}_{x} ) - 0.5 \\ {P}_{y} = {R}_{y} + 0 \text{.5} - ceil ( P / {R}_{y} ) \\ P = ( {P}_{x} + d / 2 ) + ( {R}_{x} - d / 2 - {P}_{y} ) \times {R}_{x}\end{matrix} ;$$
wherein Pₓ and P_{y} represents solutions calculated by the artificial bee colony algorithm, corresponding to coordinate information of a pipe node mapped onto a grid map, P represents pipe node information, mod represents a modulo calculation, ceil represents a round-up calculation, d represents a grid size, and Rₓ and R_{y} represents a number of rows and a number of columns of the grid map, respectively.
